(19) United States
(12) Patent Application Publication
(10) Pub. No.: US 2025/0262980 A1
(43) Pub. Date: Aug. 21, 2025

(54) INFORMATION PROCESSING DEVICE

(71) Applicant: TOYOTA JIDOSHA KABUSHIKI KAISHA, Toyota-shi (JP)

(72) Inventor: Masaya HIZAKI, Nagareyama-shi (JP)

(73) Assignee: TOYOTA JIDOSHA KABUSHIKI KAISHA, Toyota-shi (JP)

(21) Appl. No.: 18/955,992

(22) Filed: Nov. 22, 2024

(30) Foreign Application Priority Data
Feb. 20, 2024 (JP) 2024-023512

(51) Int. Cl. B60L 58/12; B60L 1/00; G07C 5/00; H04W 4/40

(52) U.S. Cl. CPC B60L 58/12; B60L 1/00; G07C 5/008; H04W 4/40

(57) ABSTRACT

The information processing device controls a vehicle equipped with a communication terminal that performs communication related to remote operation. In the information processing device, the control unit acquires a first remaining battery charge level, which is a remaining battery amount of the first battery that supplies electric power to the communication terminal. In addition, the control unit acquires a second remaining battery charge level, which is a remaining battery amount of the second battery that supplies electric power to the driving motor of the vehicle. The control unit switches between the standby state and the stop state of the communication terminal according to the acquired first remaining battery charge level and second remaining battery charge level.

### CROSS-REFERENCE TO RELATED APPLICATION

This application claims priority to Japanese Patent Application No. 2024-023512 filed on Feb. 20, 2024, incorporated herein by reference in its entirety.

### BACKGROUND

### 1. Technical Field

The present disclosure relates to an information processing device.

### 2. Description of Related Art

There is known a technology for remotely operating an air conditioner mounted on a vehicle (see, for example, Japanese Unexamined Patent Application Publication No. 2012-188062 (JP 2012-188062 A)).

### SUMMARY

An object of the present disclosure is to provide a technology capable of improving convenience for a user when remotely operating a vehicle.

An aspect of the present disclosure is an information processing device configured to control a vehicle including a communication terminal configured to perform communication related to remote operation. In that case, the information processing device may include, for example, a control unit configured to perform:
acquiring a first remaining battery charge level that is a remaining charge level of a first battery that supplies electric power to the communication terminal;
acquiring a second remaining battery charge level that is a remaining charge level of a second battery that supplies electric power to a drive motor of the vehicle; and
switching a standby state and a stop state of the communication terminal according to the first remaining battery charge level and the second remaining battery charge level.

Another aspect of the present disclosure may be an information processing method in which a computer performs the processes of the information processing device described above, a program for causing the computer to perform the information processing method, or a non-transitory storage medium storing the program in a form readable by the computer.

According to the present disclosure, it is possible to provide the technology capable of improving the convenience for the user when remotely operating the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment;

FIG. 2 is a diagram illustrating conditions under which a communication terminal is controlled to be in a standby state and a stop state in the embodiment;

FIG. 3 is a time chart illustrating an exemplary change over time in the state of the first remaining battery charge level, the second remaining battery charge level, the charging state of the auxiliary battery, the charging state of the driving battery, and the state of the communication terminal in the embodiment; and

FIG. 4 is a flowchart illustrating an example of a processing routine executed by the power management apparatus according to the embodiment.

### DETAILED DESCRIPTION OF EMBODIMENTS

A service (hereinafter, also referred to as “remote service”) in which a user remotely operates an in-vehicle device such as an air conditioner and a door lock actuator of a parked vehicle through a terminal such as a smartphone has become widespread. A vehicle that is a target of remote service is equipped with a communication terminal for transmitting and receiving a signal related to remote operation. If the communication terminal continues to stand by in the standby state when the vehicle is in the operation stop state, the remaining battery for the communication terminal may be too low or deterioration of the battery may be promoted. The operation stop state of the vehicle is a state in which the ignition switch or the power switch is off. The standby state of the communication terminal is a state in which a signal related to a remote operation can be transmitted and received.

On the other hand, a countermeasure is conceivable in which the communication terminal is automatically switched from the standby state to the stop state at a time point when a certain period of time (for example, about several days) has clapsed from the stop of the operation of the vehicle. The stop of the operation of the vehicle is a timing at which the power switch or the ignition switch is switched from on to off. The stop state of the communication terminal is a state in which a signal related to a remote operation cannot be transmitted and received. Incidentally, in a vehicle equipped with a driving battery in addition to the battery for the communication terminal, such as Battery Electric Vehicle (BEV) or Plug-in Hybrid Electric Vehicle (PHEV), when the remaining amount of the battery for the communication terminal is reduced, the auxiliary battery can be charged using the electric power of the driving battery. Therefore, in BEV, PHEV, and the like, it is required to flexibly switch the status of the communication device considering not only the remaining amount of the auxiliary battery but also the remaining amount of the driving battery.

Therefore, in the information processing device according to the present disclosure, the control unit acquires the first remaining battery charge level, which is the remaining battery capacity of the first battery. The first battery is a secondary battery mounted in a vehicle, and supplies electric power to a communication terminal. The first battery may be a battery dedicated to the communication terminal, or may be a battery for an auxiliary device that is used by both the communication terminal and the auxiliary device of the vehicle. The communication terminal is a terminal mounted on the vehicle and performs communication related to remote operation of the vehicle with a device outside the vehicle. The first remaining battery charge level may be State Of Charge (SOC of the first battery).

Further, in the information processing device according to the present disclosure, the control unit acquires the second remaining battery charge level, which is the remaining battery capacity of the second battery. The second battery is a secondary battery that supplies electric power to the drive motor of the vehicle. The driving motor is an electric motor that drives driving wheels of the vehicle. The second remaining battery charge level may be SOC of the second battery.

The acquisition of the first remaining battery charge level, the acquisition of the second remaining battery charge level, and the switching of the state of the communication terminal may be repeatedly performed at a predetermined cycle (for example, about several hundred milliseconds to several minutes) when the vehicle is in the operation stop state. The operation stop state of the vehicle is a state in which the power switch or the ignition switch is off.

The control unit of the information processing device according to the present disclosure switches between the standby state and the stop state of the communication terminal according to the acquired first remaining battery charge level and second remaining battery charge level. For example, when the first remaining battery charge level is equal to or greater than the first threshold value, the control unit may control the communication terminal to be in the standby state. In an example, the first threshold value may be a remaining battery amount (or a remaining battery amount obtained by adding a margin to the remaining battery amount) that is assumed to be likely to cause a trouble in the operation of the communication terminal and/or the auxiliary equipment when the first remaining battery charge level becomes less than the first threshold value. The first threshold value may be a remaining battery amount (or a remaining battery amount obtained by adding a margin to the remaining battery amount) that is assumed to be likely to promote deterioration of the first battery. When the first remaining battery charge level is less than the first threshold value and the second remaining battery charge level is equal to or greater than the second threshold value, the control unit may control the communication terminal to the standby state while charging the first battery from the second battery. In an example, the second threshold value may be a remaining battery amount (or a remaining battery amount obtained by adding a margin to the remaining battery amount) that is assumed to be likely to hinder the traveling of the vehicle when the second remaining battery charge level becomes less than the second threshold value. Further, when the first remaining battery charge level is less than the first threshold value and the second remaining battery charge level is less than the second threshold value, the control unit may control the communication terminal to be in the stopped state.

According to the information processing device of the present disclosure, even if the first remaining battery charge level decreases to less than the first threshold value after the operation of the vehicle is stopped, the communication terminal can continue to stand by in the standby state as long as the second remaining battery charge level is equal to or greater than the second threshold value. As a result, it is possible to increase an opportunity for the communication terminal to continue to stand by in the standby state while preventing the operation of the communication terminal and/or the auxiliary device from being hindered and promoting the deterioration of the first battery. As a result, it is possible to improve convenience for the user when the vehicle is remotely operated.

In a vehicle equipped with the second battery as described above, the second battery may be charged by using an external power supply while the vehicle is stopped. Therefore, after the communication terminal is controlled to be in the stopped state in response to the first remaining battery charge level being less than the first threshold value and the second remaining battery charge level being less than the second threshold value, the second battery capacity may be increased to the second threshold value or more by charging the second battery with an external power supply. Therefore, in the information processing device according to the present disclosure, after the communication terminal is controlled to be in the stopped state in response to the first remaining battery charge level being less than the first threshold value and the second remaining battery charge level being less than the second threshold value, the second remaining battery charge level is increased to be equal to or greater than the second threshold value by charging the second battery with the external power supply. Accordingly, the control unit may switch the communication terminal from the stopped state to the standby state while charging the first battery from the second battery. This makes it possible to more reliably increase the opportunity for the communication terminal to continue to stand by in the standby state. As a result, the convenience of the user when the vehicle is remotely operated can be improved more reliably.

### Embodiment

Hereinafter, embodiments of the present disclosure will be described with reference to the drawings. The configurations of the following embodiments are merely examples, and the embodiments described below are merely examples of the present disclosure in all respects. Various modifications or variations may be made without departing from the scope of the present disclosure. In the implementation of the present disclosure, a specific configuration according to the embodiment may be adopted as appropriate. Although the data appearing in the present embodiment is described in a natural language, more specifically, the data is designated by a pseudo language, a command, a parameter, a machine language, or the like that can be recognized by a computer.

### System Configuration

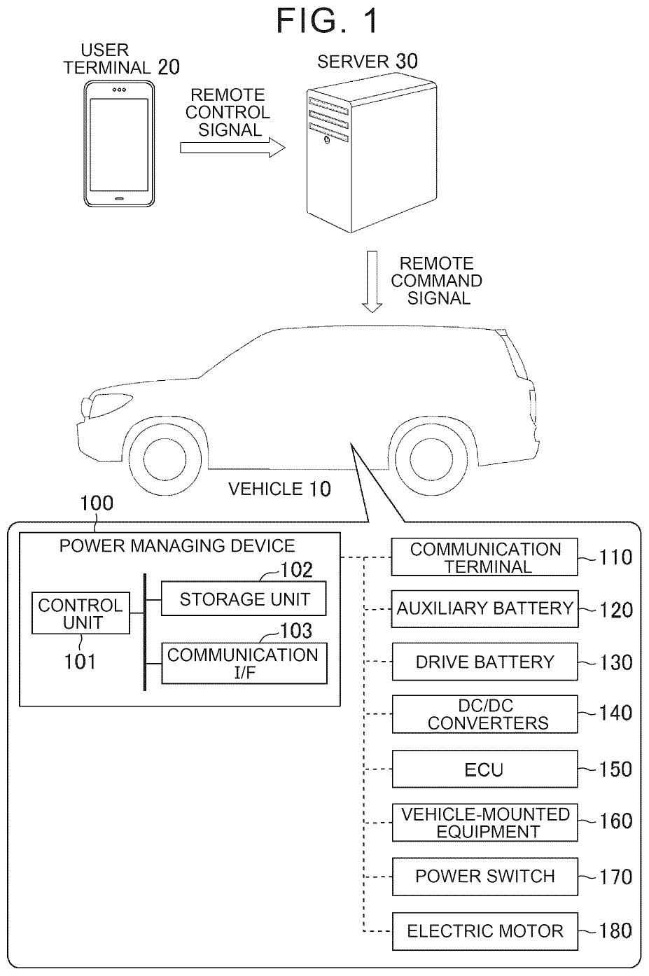

FIG. 1 is a diagram schematically illustrating an example of a configuration of a system to which the present disclosure is applied. The system according to the present embodiment includes a vehicle 10, a user terminal 20, and a server 30, and provides a remote service to a user of the vehicle 10. The remote service is a service in which a user remotely operates the vehicle 10 through the user terminal 20.

The vehicles 10, the user terminals 20, and the servers 30 are connected via a network N1. The network N1 may be, for example, a Wide Area Network (WAN that is a global public communication network such as the Internet, or another communication network. In addition, the network N1 may include a telephone communication network such as a mobile phone network and a wireless communication network such as Wi-Fi (registered trademark). Although only one vehicle 10 and one user terminal 20 are illustrated in FIG. 1, a plurality of vehicles 10 and a plurality of user terminals 20 managed by the server 30 may be included in the system.

The vehicles 10 are BEV on which the auxiliary battery 120 and the driving battery 130 are mounted. The vehicles 10 are not limited to BEV, and may be PHEV equipped with an auxiliary battery and a driving battery. The vehicle 10 has a function of operating the in-vehicle device 160 in accordance with a remote command signal transmitted from the server 30. In addition, the vehicle 10 according to the present embodiment has a function of switching between the standby state and the stop state of the communication terminal 110 in accordance with the remaining battery capacity of the auxiliary battery 120 and the driving battery 130. The standby state of the communication terminal 110 is a state in which a remote command signal transmitted from the server 30 can be received, and the stop state is a state in which a remote command signal transmitted from the server 30 cannot be received. Details of the vehicle 10 will be described later.

The user terminal 20 is a computer used by a user of the vehicle 10. The user terminal 20 has a function of receiving a remote operation performed by a user, and a function of transmitting a remote operation signal including information related to the received remote operation (for example, an operation method of an in-vehicle device that is a target of remote operation, and the like) to the server 30. Such a user terminal 20 may, in one example, be a terminal carried by a user (e.g., a smartphone, a tablet terminal, or the like).

The server 30 is one or more computers that perform processing related to remote operation of the vehicle 10. The server 30 has a function of transmitting, to the vehicle 10, a remote command signal for operating the in-vehicle device of the target vehicle 10 by the operation method included in the remote operation signal in response to receiving the remote operation signal transmitted from the user terminal 20.

### Configuration of Vehicle

The vehicle 10 according to the present embodiment includes a power managing device 100, a communication terminal 110, an auxiliary battery 120, a driving battery 130, a DC/DC converter 140, an ECU 150, an in-vehicle device 160, a power switch 170, an electric motor 180, and the like. The power managing device 100, the communication terminal 110, the auxiliary battery 120, the driving battery 130, DC/DC converter 140, ECU 150, the in-vehicle device 160, and the power switch 170 are connected to each other through an in-vehicle network based on a standard such as Controller Arca Network (CAN), Local Interconnect Network (LIN), or FlexRay.

The power managing device 100 can be configured as a computer including a processor (such as a CPU or a GPU), a main storage device (such as a RAM and a ROM), and a secondary storage device (such as a EPROM, a hard disk drive, and a removable medium). In one embodiment, the power managing device 100 may be configured by combining one or more Electronic Control Unit (ECU). In the present embodiment, the power managing device 100 corresponds to an information processing device according to the present disclosure. The power managing device 100 includes a control unit 101, a storage unit 102, and a communication I/F103.

The control unit 101 implements various functions of the power managing device 100 by executing a dedicated program stored in the storage unit 102. The control unit 101 can be realized by a hardware processor such as a CPU or a DSP, for example. In addition, the control unit 101 may be configured to include a RAM, Read Only Memory (ROM), a cache memory, and the like in addition to the hardware processor. Details of the functions realized by the control unit 101 will be described later.

The storage unit 102 includes an auxiliary storage device and stores various types of information. Note that the storage unit 102 may be a storage area constructed in the auxiliary storage device. The information stored in the storage unit 102 includes, in addition to OS, a dedicated program for controlling the status of the communication terminal 110, data used by the program, and the like.

The communication I/F103 includes communication interfaces for connecting the power managing device 100 to an in-vehicle network. The communication I/F103 of the present embodiment communicates with each of the communication terminal 110, the auxiliary battery 120, and the driving battery 130 through the in-vehicle network.

Next, the communication terminal 110 of the vehicle 10 is a computer having a function of communicating with the server 30 through an out-of-vehicle network and a function of communicating with the power managing device 100 through an in-vehicle network. The communication terminal 110 has a function of transmitting a remote command received from the servers 30 to ECU 150. Further, in the present embodiment, the communication terminal 110 has a function of switching between the standby state and the stop state in accordance with a command from the power managing device 100.

The auxiliary battery 120 of the vehicle 10 is a secondary battery that supplies electric power to electrical components (auxiliary devices) such as a communication terminal 110, a door lock actuator, a power window actuator, a car navigation system, a lighting device, and a wiper. The auxiliary battery 120 is configured to be chargeable by using electric power of the driving battery 130. In the present embodiment, the auxiliary battery 120 corresponds to the first battery according to the present disclosure.

The driving battery 130 of the vehicle 10 is a secondary battery that supplies electric power to an electric motor 180, which will be described later. The driving battery 130 is configured to be chargeable by using electric power generated (regenerative power generation) by converting kinetic energy of driving wheels when the vehicle 10 is decelerating to electric energy and electric power supplied from an external power supply. In the present embodiment, the driving battery 130 corresponds to the second battery according to the present disclosure.

When charging the auxiliary battery 120 from the driving battery 130, DC/DC converters 140 of the vehicles 10 convert the voltage supplied from the driving battery 130 to the auxiliary battery 120 into a voltage suitable for the auxiliary battery 120.

ECU 150 of the vehicle 10 is a computer that controls the in-vehicle device 160. The in-vehicle device 160 includes an air conditioner, a door lock actuator, a power window actuator, and the like mounted on the vehicle 10. ECU 150 operates the in-vehicle device 160 in accordance with the remote command received by the communication terminal 110 from the servers 30.

The power switch 170 of the vehicle 10 is a switch for the user to switch between the operation of the vehicle 10 (the power switch 170 is turned on) and the operation stop of the vehicle 10 (the power switch 170 is turned off).

The electric motor 180 is a motor for driving drive wheels of the vehicle 10. The electric motor 180 may be a motor generator having a function as a motor for driving the drive wheels and a function as a generator for converting kinetic energy of the drive wheels into electric energy.

### Power Management Unit Features

Next, the details of the functions realized by the control unit 101 of the power managing device 100 will be described. Note that the functions described below may be realized by hardware circuitry such as Application Specific Integrated Circuit (ASIC) or Field Programmable Gate Array (FPGA).

The control unit 101 of the power managing device 100 according to the present embodiment has a function of controlling the charging and discharging of each of the auxiliary battery 120 and the driving battery 130. In addition, the control unit 101 has a function of controlling charging from the driving battery 130 to the auxiliary battery 120, and a function of controlling the state of the communication terminal 110 when the vehicle 10 is in the deactivated state.

Here, a function of controlling charging from the driving battery 130 to the auxiliary battery 120 will be described. The control unit 101 acquires the remaining battery capacity of each of the auxiliary battery 120 and the driving battery 130 at a predetermined cycle (for example, about several hundred milliseconds to several minutes). In this case, the remaining battery capacity may be, for example, SOC of each of the auxiliary battery 120 and the driving battery 130.

The control unit 101 controls DC/DC converters 140 to charge the auxiliary battery 120 from the driving battery 130 when the acquired remaining battery capacity of the auxiliary battery 120 (hereinafter, sometimes referred to as “first remaining battery charge level”) is less than the first threshold value and the acquired remaining battery capacity of the driving battery 130 (hereinafter, sometimes referred to as “second remaining battery charge level”) is equal to or greater than the second threshold value. Specifically, the control unit 101 controls DC/DC converters 140 so that the voltage supplied from the driving battery 130 to the auxiliary battery 120 is converted into a voltage suitable for the auxiliary battery 120. Here, the “first threshold” may be, in an example, a battery remaining amount that is assumed to be likely to cause a trouble in the operation of the communication terminal 110 and/or the in-vehicle device 160 when the first remaining battery charge level becomes less than the first threshold value. Alternatively, the “first threshold” may be a remaining battery amount obtained by adding a margin to the remaining battery amount. As another example, the “first threshold value” may be a remaining battery amount that is assumed to be likely to promote deterioration of the auxiliary battery 120 or a remaining battery amount obtained by adding a margin to the remaining battery amount. Further, in an example, the “second threshold value” may be a remaining battery amount which is assumed to be likely to cause a trouble in traveling of the vehicle 10 when the second remaining battery charge level becomes less than the second threshold value, or a remaining battery amount which is obtained by adding a margin to the remaining battery amount.

After the charging of the auxiliary battery 120 from the driving battery 130 is started, when the first remaining battery charge level is increased to the first threshold or more, the control unit 101 controls DC/DC converters 140 so as to stop the charging of the auxiliary battery 120 from the driving battery 130. Note that before the first remaining battery charge level increases to the first threshold value or more, the second remaining battery charge level may decrease to less than the second threshold value. In this case, the control unit 101 may stop the charging from the driving battery 130 to the auxiliary battery 120 at a timing when the second remaining battery charge level is lowered to less than the second threshold value. However, in a state in which the second battery is charged by the external power supply, the charging from the driving battery 130 to the auxiliary battery 120 may be continued until the first remaining battery charge level increases to the first threshold value or more.

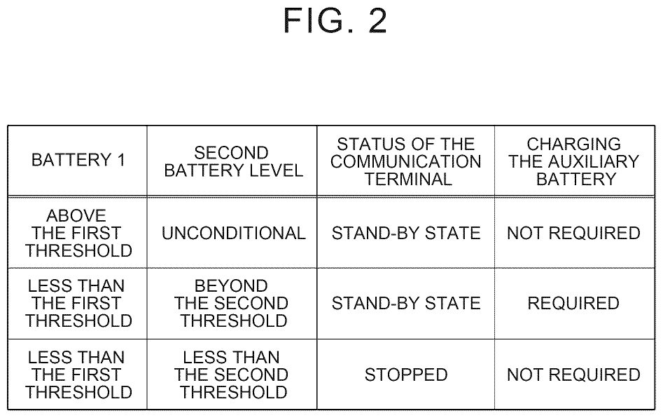

Next, a function of controlling the state of the communication terminal 110 when the vehicle 10 is in the deactivated state will be described with reference to FIG. 2. FIG. 2 is a diagram illustrating conditions under which the communication terminal 110 is controlled to be in the standby state and the stopped state. The control unit 101 has a function of repeatedly executing the following processing in a predetermined cycle (for example, about several hundred milliseconds to several minutes) in response to switching of the power switch 170 from on to off.

First, the control unit 101 acquires a first remaining battery charge level that is the remaining battery amount of the auxiliary battery 120 and a second remaining battery charge level that is the remaining battery amount of the driving battery 130. In one embodiment, the control unit 101 calculates SOC of each of the auxiliary battery 120 and the driving battery 130 using a known method such as a OCV method or a current integration method, and acquires SOC as the first remaining battery charge level and the second remaining battery charge level.

Next, the control unit 101 determines whether or not the first remaining battery charge level is equal to or greater than the first threshold. When it is determined that the first remaining battery charge level is equal to or greater than the first threshold value, the control unit 101 controls the communication terminal 110 to be in the standby state by supplying electric power from the auxiliary battery 120 to the communication terminal 110. Thus, when the first remaining battery charge level is equal to or greater than the first threshold value, the communication terminal 110 is controlled to be in the standby state regardless of whether the second remaining battery charge level is equal to or greater than the second threshold value, as illustrated in FIG. 2. Further, charging from the driving battery 130 to the auxiliary battery 120 is not performed.

When it is determined that the first remaining battery charge level is less than the first threshold value, the control unit 101 determines whether the second remaining battery charge level is equal to or greater than the second threshold value. When it is determined that the second remaining battery charge level is equal to or greater than the second threshold value, the control unit 101 supplies electric power from the driving battery 130 to the auxiliary battery 120 through DC/DC converters 140. By doing so, the control unit 101 controls the communication terminal 110 to be in the standby state by charging the auxiliary battery 120 and supplying electric power from the auxiliary battery 120 to the communication terminal 110. Thus, when the first remaining battery charge level is less than the first threshold value and the second remaining battery charge level is equal to or greater than the second threshold value, as shown in FIG. 2, the communication terminal 110 is controlled to be in the standby state on condition that charging from the driving battery 130 to the auxiliary battery 120 is performed.

When it is determined that the second remaining battery charge level is less than the second threshold value, the control unit 101 stops the power supply from the auxiliary battery 120 to the communication terminal 110 and controls the communication terminal 110 to be in the stopped state. Thus, when the first remaining battery charge level is less than the first threshold value and the second remaining battery charge level is less than the second threshold value, as shown in FIG. 2, the communication terminal 110 is controlled to be in a stopped state.

Note that the second remaining battery charge level may be acquired only when it is determined that the first remaining battery charge level is less than the first threshold value. That is, when it is determined that the first remaining battery charge level is equal to or greater than the first threshold value, the second remaining battery charge level may not be acquired.

In the present embodiment, even after the communication terminal 110 is controlled to be in the stopped state, the control unit 101 performs acquisition of the first remaining battery charge level, acquisition of the second remaining battery charge level, determination of whether the first remaining battery charge level is equal to or greater than the first threshold value, and determination of whether the second remaining battery charge level is equal to or greater than the second threshold value in a predetermined cycle. Thus, when the battery 130 for driving is charged by the external power supply and the second remaining battery charge level increases to the second threshold value or more, the control unit 101 can return the communication terminal 110 from the stopped state to the standby state while charging the battery 120 for auxiliary machinery from the battery 130 for driving.

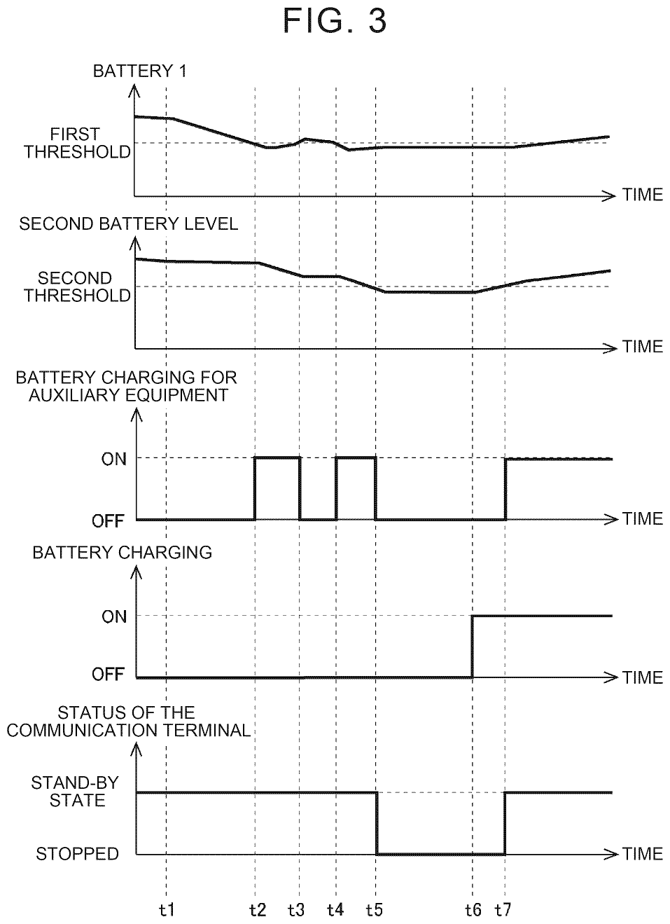

Here, an example of a time chart of the state of the first remaining battery charge level, the second remaining battery charge level, the state of charge of the auxiliary battery 120, the state of charge of the driving battery 130, and the state of the communication terminal 110 after the power switch 170 is switched from ON to OFF is shown in FIG. 3.

In FIG. 3, during a period from a time point when the power switch 170 is switched from on to off (t1 in FIG. 3) to a time point when the first remaining battery charge level is reduced to less than the first threshold (t2 in FIG. 3), the battery 120 for auxiliary machinery is not charged from the battery 130 for driving. In this period, the communication terminal 110 is controlled to be in the standby state (power is supplied from the auxiliary battery 120 to the communication terminal 110). During a time period from a time point when the first remaining battery charge level is decreased to less than the first threshold value (t2 in FIG. 3) to a time point when the first remaining battery charge level is increased to the first threshold value or more (t3 in FIG. 3), the driving battery 130 charges the auxiliary battery 120 and the communication terminal 110 remains in the standby state. During a time period from a time point when the first remaining battery charge level is increased to the first threshold value or more (t3 in FIG. 3) to a time point when the first remaining battery charge level is decreased to less than the first threshold value (t4 in FIG. 3), the charge from the driving battery 130 to the auxiliary battery 120 is stopped, and the standby status of the communication terminal 110 is maintained. Thereafter, when the first remaining battery charge level is decreased to less than the first threshold value (t4 in FIG. 3), the charge from the driving battery 130 to the auxiliary battery 120 is resumed, and the standby status of the communication terminal 110 is maintained. When the charging from the driving battery 130 to the auxiliary battery 120 is repeatedly executed in this manner, and the second remaining battery charge level is decreased to less than the second threshold value (t5 in FIG. 3), the charging from the driving battery 130 to the auxiliary battery 120 is terminated. Then, as illustrated in FIG. 3, when the first remaining battery charge level at the time point (15 in FIG. 3) at which the second remaining battery charge level decreases to less than the second threshold value is less than the first threshold value, the communication terminal 110 is switched from the standby state to the stopped state. Thereafter, when the charging of the driving battery 130 by the external power supply is started (t6 in FIG. 3), and the second remaining battery charge level is increased to the second threshold value or more (t7 in FIG. 3), the charging from the driving battery 130 to the auxiliary battery 120 is resumed, and the communication terminal 110 is switched from the stopped state to the standby state.

In the exemplary embodiment shown in FIG. 3, the charge from the driving battery 130 to the auxiliary battery 120 is stopped at a time point (t3 in FIG. 3) when the first remaining battery charge level is increased to be equal to or greater than the first threshold value. However, charging from the driving battery 130 to the auxiliary battery 120 may be performed until the first remaining battery charge level becomes equal to or larger than the third threshold value that is larger than the first threshold value. Alternatively, the charging from the driving battery 130 to the auxiliary battery 120 may be continued until the second remaining battery charge level decreases to less than the second threshold value regardless of whether the first remaining battery charge level is equal to or greater than the first threshold value. In this case, if the first remaining battery charge level at the time point when the second remaining battery charge level decreases to less than the second threshold value is equal to or greater than the first threshold value, the standby state of the communication terminal 110 may be maintained until the first remaining battery charge level decreases to less than the first threshold value.

Further, in the embodiment shown in FIG. 3, at a time point (in t7 in FIG. 3) when the second remaining battery charge level is increased to the second threshold value or more by charging from the external power supply to the driving battery 130, the charging from the driving battery 130 to the auxiliary battery 120 is resumed, and the communication terminal 110 is switched from the stopped state to the standby state. However, when the second remaining battery charge level increases to the fourth threshold value or more that is larger than the second threshold value, the charging from the driving battery 130 to the auxiliary battery 120 may be resumed, and the communication terminal 110 may be switched from the stopped state to the standby state.

### Processing Flow

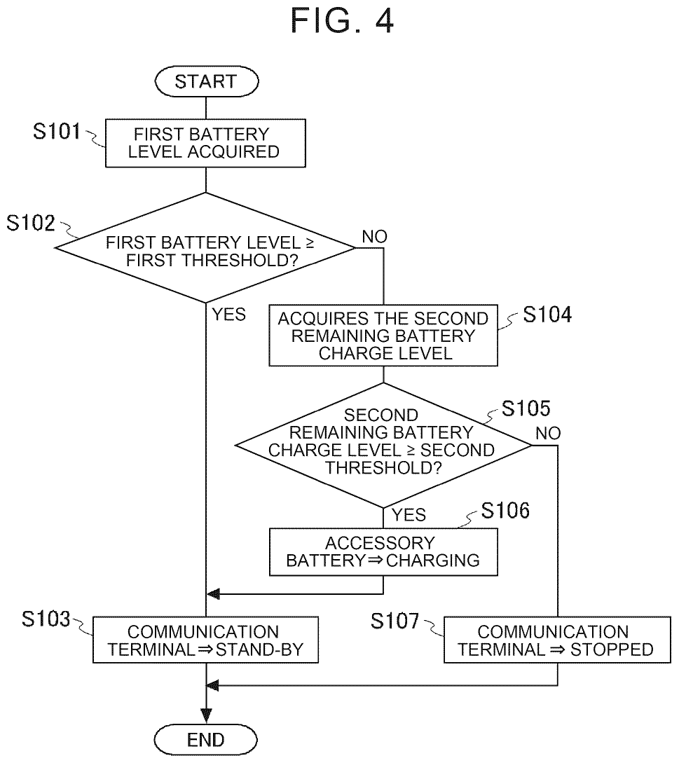

Next, a flow of processing executed by the power managing device 100 according to the present embodiment will be described with reference to FIG. 4. FIG. 4 is a flowchart illustrating an example of a processing routine that is repeatedly executed at a predetermined cycle in the power managing device 100 when the vehicle 10 is in the operation stop state (the power switch 170 is in the off state).

In the process of FIG. 4, the control unit 101 first calculates SOC of the auxiliary battery 120 and acquires the calculated SOC as the first remaining battery charge level (S101). Upon completion of S101 process, the control unit 101 executes S102 process.

In S102, the control unit 101 determines whether the first remaining battery charge level acquired by S101 is equal to or greater than the first threshold. As described above, the first threshold value may be a battery remaining amount (or a battery remaining amount obtained by adding a margin to the battery remaining amount) that is assumed to be likely to cause a trouble in the operation of the communication terminal 110 and/or the in-vehicle device 160 when the first remaining battery charge level becomes less than the first threshold value. Alternatively, the first threshold value may be a remaining battery amount (or a remaining battery amount obtained by adding a margin to the remaining battery amount) that is assumed to be likely to promote deterioration of the auxiliary battery 120. When the first remaining battery charge level is equal to or greater than the first threshold value (affirmative determination is made by S102), the control unit 101 executes S103 process. On the other hand, when the first remaining battery charge level is less than the first threshold (negative determination in S102), the control unit 101 executes S104 process.

In S103, the control unit 101 controls the communication terminal 110 to be in the standby status by supplying power from the auxiliary battery 120 to the communication terminal 110. When the control unit 101 finishes executing $103 processing, it temporarily finishes executing this processing routine.

In addition, in S104, the control unit 101 calculates SOC of the driving battery 130 and acquires the calculated SOC as the second remaining battery charge level. Upon completion of S104 process, the control unit 101 executes S105 process.

In S105, the control unit 101 determines whether the second remaining battery charge level acquired by S104 is equal to or greater than the second threshold. As described above, the second threshold value may be a remaining battery amount which is assumed to be likely to cause a trouble in traveling of the vehicle 10 when the second remaining battery charge level becomes less than the second threshold value, or a remaining battery amount which is obtained by adding a margin to the remaining battery amount. When the second remaining battery charge level is equal to or greater than the second threshold value (affirmative determination in S105), the control unit 101 executes S106 process. On the other hand, when the second remaining battery charge level is less than the second threshold (negative determination in S105), the control unit 101 executes S107 process.

In S106, the control unit 101 controls DC/DC converters 140 so that the auxiliary battery 120 is charged from the driving battery 130. Specifically, the control unit 101 controls DC/DC converters 140 so that the voltage supplied from the driving battery 130 to the auxiliary battery 120 is converted into a voltage suitable for the auxiliary battery 120. Upon completion of S106 process, the control unit 101 proceeds to S103 process and controls the communication terminal 110 to be in the standby mode.

In S107, the control unit 101 stops supplying power from the auxiliary battery 120 to the communication terminal 110, thereby controlling the communication terminal 110 to be stopped. When the control unit 101 finishes executing S107 processing, it temporarily finishes executing this processing routine.

According to the embodiment described above, as described with reference to FIGS. 2 and 3, in addition to the period in which the first remaining battery charge level is equal to or greater than the first threshold value, the communication terminal 110 can be made to stand by in the standby state even in a period in which the first remaining battery charge level is less than the first threshold value and the second remaining battery charge level is equal to or greater than the second threshold value. As a result, the communication terminal 110 can be made to stand by in the standby state even in a period from when the first remaining battery charge level is reduced to less than the first threshold value, and the second remaining battery charge level is reduced to less than the second threshold value, in addition to a period from when the first remaining battery charge level is reduced to less than the first threshold value since the vehicle 10 is stopped. The stop of the operation of the vehicle 10 is a timing at which the power switch 170 is turned from on to off. Further, even after the second remaining battery charge level is lowered to less than the second threshold value, the charging of the driving battery 130 from the external power supply is performed, and thus, when the second remaining battery charge level is increased to the second threshold value or more, the communication terminal 110 can be automatically restored from the stopped state to the standby state.

Therefore, according to the present embodiment, it is possible to increase an opportunity to cause the communication terminal 110 to stand by in a standby state while suppressing disturbance to the operation of the communication terminal 110 and the auxiliary machine or promoting deterioration of the auxiliary machine battery 120. As a result, the convenience of the user using the service can be enhanced.

### Other

The above-described embodiment is merely an example, and the present disclosure can be appropriately modified and implemented without departing from the gist thereof. In addition, the processes and means described in the present disclosure can be freely combined and implemented as long as there is no technical inconsistency. Moreover, the processes described as being executed by one device may be shared and executed by a plurality of devices. Further, the present disclosure can also be realized by supplying a computer program having the functions described in the above embodiments to the power managing device 100, and one or more processors included in the power managing device 100 read and execute the computer program.

What is claimed is:

1. An information processing device configured to control a vehicle including a communication terminal configured to perform communication related to remote operation, the information processing device comprising a control unit configured to perform:
acquiring a first remaining battery charge level that is a remaining charge level of a first battery that supplies electric power to the communication terminal;
acquiring a second remaining battery charge level that is a remaining charge level of a second battery that supplies electric power to a drive motor of the vehicle; and
switching a standby state and a stop state of the communication terminal according to the first remaining battery charge level and the second remaining battery charge level.

2. The information processing device according to claim 1, wherein the switching of the standby state and the stop state of the communication terminal according to the first remaining battery charge level and the second remaining battery charge level includes:
controlling the communication terminal into the standby state when the first remaining battery charge level is equal to or higher than a first threshold value;
controlling the communication terminal into the standby state while charging the first battery with the second battery when the first remaining battery charge level is lower than the first threshold value and the second remaining battery charge level is equal to or higher than a second threshold value; and
controlling the communication terminal into the stop state when the first remaining battery charge level is lower than the first threshold value and the second remaining battery charge level is lower than the second threshold value.

3. The information processing device according to claim 2, wherein:
the second battery is a battery chargeable with an external power supply; and
the control unit is configured to, when the second remaining battery charge level is increased to the second threshold value or higher by charging the second battery with the external power supply after the communication terminal is brought into the stop state when the first remaining battery charge level is lower than the first threshold value and the second remaining battery charge level is lower than the second threshold value, switch the communication terminal from the stop state to the standby state while charging the first battery with the second battery.
